(19) United States
(12) Patent Application Publication
(10) Pub. No.: US 2011/0203156 A1
(43) Pub. Date: Aug. 25, 2011

(54) STRIKE INDICATOR FOR FISHING LINE

(76) Inventor: Bart G. Christiansen, Elizabeth, CO (US)

(21) Appl. No.: 12/791,522

(22) Filed: Jun. 1, 2010

Related U.S. Application Data
(60) Provisional application No. 61/183,195, filed on Jun. 2, 2009.

(51) Int. Cl. A01K 97/12; A01K 91/16

(52) U.S. Cl. 43/17; 43/43.1

(57) ABSTRACT

One embodiment of a strike indicator may be constructed of a buoyant member having a curved outer surface, a central axis and a slot extending from the outer surface to the central axis. This slot is used to hold the fishing line. A securing member is removably coupled to the outer surface of the buoyant member. The securing member has a protrusion that can be positioned within the slot such that the line does not slide within the slot when casting the line.

### CROSS REFERENCE TO RELATED APPLICATIONS

This application is a non-provisional application and claims the benefit of U.S. Provisional Application No. 61/183,195, filed Jun. 2, 2009, the complete disclosure of which is herein incorporated by reference.

### BACKGROUND OF THE INVENTION

This invention relates generally to the field of fly fishing, and more specifically to the field of strike indicators that are attached to the fisherman's fly line.

Many fly fishers prefer dry fly fishing where the fish rise to the surface to take the fly. However, during certain times of the season and/or the day, there is no surface activity. As such, the fisherman often resorts to subsurface fishing with nymphs. While nymph fishing can be very productive, it is difficult because the nymph needs to be presented in a dead drift manner. When fishing in this manner, many fisherman choose to fish with a strike indicator which is some visible object that is attached to the leader to let the angler know that the drift of a sunken fly has been halted by a feeding fish. In other words, when the floating strike indicator moves or jerks, there is a strong likelihood that a feeding fish has taken the fly beneath the surface. At this point, the fisherman lifts up his pole in an attempt to gently set the hook in the fish's mouth.

A wide variety of strike indicators are currently in use, including “bobber-type” indicators, yarn, a dry fly and even a greased leader. Bobber indicators are typically made of cork, plastic or foam and float high enough on the water to suspend the fly in the water. One particular type of bobber strike indicator is a circular piece of foam with an adhesive backing that is pinched about the fly line so that it sticks to itself. One problem with this type is that the adhesive usually doesn't work well and tends to slide along the line. The yarn, dry fly and greased leader indicators typically do not provide buoyancy and can be difficult to attach to the line.

This invention relates to a new type of buoyant strike indicator that is easy to attach to the line, is easy to see in the water, does not slide down the line or dislodge from the line and can be made in a variety of sizes, thereby providing different degrees of buoyancy.

### BRIEF SUMMARY OF THE INVENTION

The invention provides various strike indicators as well as methods for their construction and use. In one embodiment, a strike indicator comprises a buoyant member having a curved outer surface, a central axis and a slot extending from the outer surface to the central axis. This slot is used to hold the fishing line. A securing member is removably coupled to the outer surface of the buoyant member. The securing member has a protrusion that can be positioned within the slot such that the line does not slide within the slot when casting the line. In this way, after placing the line within the slot, the securing member is used to secure the line to the buoyant member.

In one particular aspect, the securing member is constructed of two halves, with a hinge connecting them. With this arrangement, the protrusion extends from one of the halves. After inserting the protrusion into the slot, one of the halves is pivoted about the buoyant member and locked with the other half. Conveniently, the buoyant member may be ellipsoidal (or football shaped) and the two halves may be semicircular in geometry so that they match the outer surface of the buoyant member. The buoyant member may be constructed of a wide variety of buoyant materials.

In one aspect, the protrusion is perpendicular to one of the halves. In another aspect, the securing member may include a clasp to releasably couple the two halves together.

To use the strike indicator, the user places the fishing line, typically the leader, into the slot of the buoyant member. The half of the securing member having the protrusion is manipulated until the protrusion is within the slot. This wedges the line within the slot so that the strike indicator will not slip along the line. The other half is positioned about the outer surface of the buoyant member and then secured to the other half. A variety of securing arrangements may be used, such as latches, detents, locks, clips and the like.

### BRIEF DESCRIPTION OF THE DRAWINGS

FIG. 1 is a perspective view of one embodiment of a strike indicator with a securing member and an open position according to the invention.

FIG. 2 is a top view of the strike indicator of FIG. 1.

FIG. 3 is an end view of the strike indicator of FIG. 1.

FIG. 4 is a perspective view of the strike indicator of FIG. 1 with the securing member in the closed position.

FIG. 5 is a side view of the strike indicator of FIG. 4.

FIG. 6 is an end view of the strike indicator of FIG. 4.

FIG. 7 is a perspective view of the securing member of the strike indicator of FIG. 1.

FIG. 8 is a top view of the securing member of FIG. 7.

FIG. 9 is a side view of the securing member of FIG. 7.

FIG. 10 is an end view of the securing member of FIG. 7.

FIG. 11 is a perspective view of a buoyant member of the strike indicator of FIG. 1.

FIG. 12 is a top view of the buoyant member of FIG. 11.

FIG. 13 is an end view of the buoyant member of FIG. 11.

FIG. 14 illustrates another embodiment of a strike indicator where the securing member is made from a single piece of material.

FIG. 15 is a side view of the strike indicator of FIG. 14.

FIG. 16 is a perspective view of the strike indicator attached to a fishing line.

FIG. 17 is an exploded view of the strike indicator of FIG. 16.

FIG. 18 is a perspective view of the buoyant member of the strike indicator of FIG. 16.

FIG. 19 is a side view of the buoyant member of FIG. 18.

FIG. 20 is a top view of the buoyant member of FIG. 18.

FIG. 21 is an end view of the buoyant member of FIG. 18.

FIG. 22 is another side view of the buoyant member of FIG. 18.

FIG. 23 is a top view of the strike indicator attached to a fishing line.

FIG. 24 is a side view of the strike indicator of FIG. 23.

FIG. 25 is a cross section view of the strike indicator of FIG. 23 with the cross section taken along the line indicated in FIG. 26.

FIG. 26 is an end view of the strike indicator of FIG. 23.

### DETAILED DESCRIPTION OF THE INVENTION

The invention provides various strike indicators that may be used in combination with a fishing line. The strike indicators may be constructed of some type of buoyant member having a slot, groove, hole, or the like through which the fishing line is passed. Also, some type of securing mechanism is used to secure the line within the slot or opening to prevent the strike indicator from slipping along the line, typically when casting the line.

A wide variety of buoyant members may be used and may have various shapes. In one embodiment, the buoyant member will be an ellipsoid, such as in the shape of a football. This shape is aerodynamic to permit the flowing water to easily pass around the strike indicator without excessive drag. A further consideration in constructing the buoyant member is that it be sized small enough so that it does not scare the fish. However, if the buoyant member is too small it does not provide sufficient buoyancy. The buoyant member should have sufficient buoyancy to suspend a weighted nymph, typically having a size in the range from about 6 to about 24, and two or more BB size split shots. The buoyant member may also be constructed of various colors and may be fluorescent to permit visualization of the strike indicator even in fast or choppy waters. Exemplary colors include red, orange, yellow, chartreuse, white, and the like.

Another important feature of the strike indicator is that it may be easily removed or readjusted along the length of the line. Often, a fisherman will wish to change from a wet nymph to a dry fly, requiring the strike indicator to be removed. The slot in the buoyant member along with the securing member allows this to be done in a simple, quick maneuver. Also, if the strike indicator needs to be moved up or down the leader, the securing member can be removed to permit the buoyant member to be easily slid along the line. When at the desired spot, the securing member can be resecured to clasp the strike indicator to the line.

The strike indicator may be placed at a wide variety of locations on the fly line. This position may vary depending on the time of day, fishing conditions, the type of fly, the amount of weight, and the like. One rule of thumb is that the strike indicator be separated from the fly by about 1½ to 2 times of the fishing depth. Another rule of thumb is to place the strike indicator at the end of the tippet so that the fly is separated from the strike member by the entire length of the tippet. Because most tippets or leaders are tapered, it is important that the securing member provides sufficient clamping force to hold the line to the buoyant member, otherwise the strike indicator will slide down the tippet while casting or when in fast, choppy water.

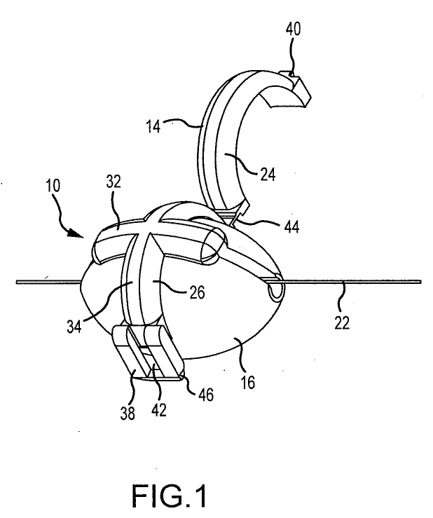

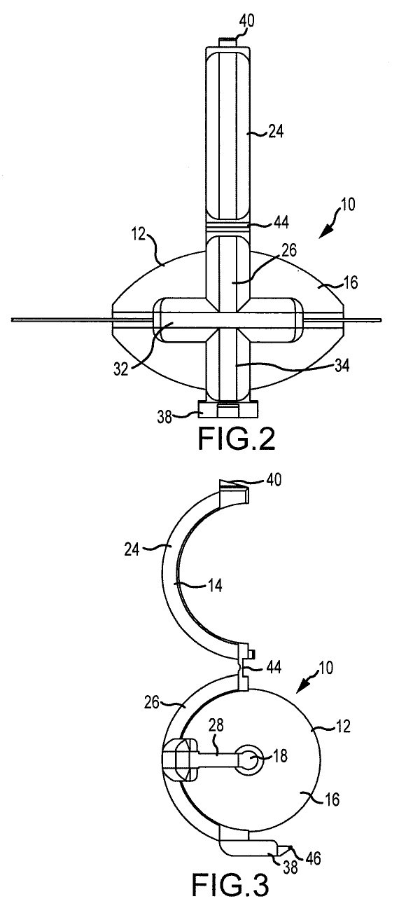

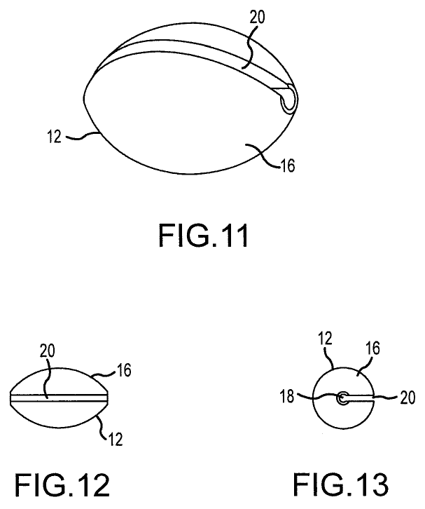

Referring now to FIGS. 1-3, one embodiment of a strike indicator 10 will be described. Strike indicator 10 is constructed of a buoyant member 12 and a securing member 14. Buoyant member 12 is further illustrated in FIGS. 11-13 and comprises a curved outer surface 16 which is typically in the shape of an ellipsoid, often referred to as “football shaped.” Buoyant member 12 further includes a central axis 18 which passes through a geometric center of buoyant member 12 as best illustrated in FIG. 13. Extending from outer surface 16 to central axis 18 is a slot 20 into which the fishing line is placed. While slot 20 extends to central axis 18, it will be appreciated that slot 20 in some cases could extend to a variety of locations within buoyant member 12. For example, slot 20 could be a simple groove into which the fishing line is placed. However, extending slot 20 the central axis provides a significant advantage in that the fishing line is geometrically aligned with the rest of buoyant member 12. This provides smoother casting and an improved float.

Buoyant member 12 is constructed of a material that will float in water and that provides sufficient buoyancy to suspend the attached fly and any weights within the water. Exemplary materials that may be used to construct buoyant member 12 include closed cell foam, and the like. In most applications, buoyant member 12 will have a maximum diameter in the range from about 18 mm to about 28 mm, and typically in the range from about 12 mm to about 18 mm. Also, the length of buoyant member 12 will typically be in the length from about 15 mm to about 25 mm, and more particularly from about 18 mm to about 21 mm. Also, slot 20 should have a size sufficient to permit a wide variety of line sizes to be inserted into the slot. Typically, slot 20 will have a width in the range from about 1 mm to about 3 mm, and more particularly about 1.0 mm to about 2.0 mm. Buoyant member 12 may further have a maximum outer diameter in the range from about 25 mm to about 35 mm, and more preferably from about 30 mm to about 32 mm. Conveniently, the ends of buoyant member 12 may be chamfered to prevent buoyant member 12 from cutting the fishing line.

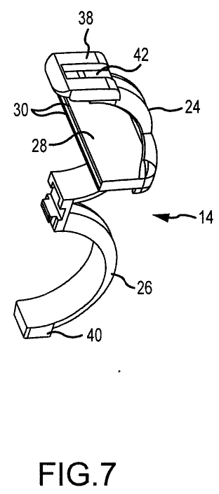

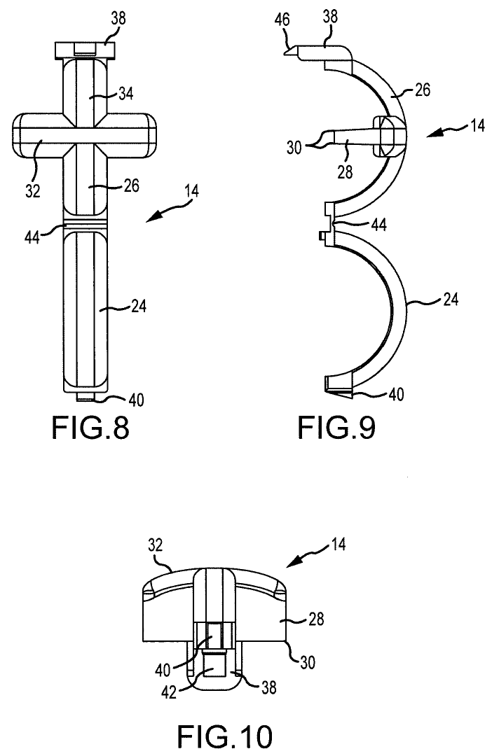

As illustrated in FIGS. 1-3, securing member 14 is in an open position where a length of fishing line 22 has not yet been completely secured within slot 20. Not shown is a strip of rubber at the bottom of slot 20 where the fly line will rest. As further illustrated in FIGS. 7-10, securing member 14 is constructed of a first portion 24 and a second portion 26. As shown, first and second portions 24 and 26 are semi-circular in geometry so as to be positioned about the circumference of buoyant member 12 at its widest diameter. First portion 24 also includes a protrusion 28 which is slidable within slot 20 of buoyant member 12. In some cases, protrusion 28 may be slightly tapered and slot 20 may also be slightly tapered. This permits protrusion 28 to be wedged within slot 20 with a press fit. This helps hold protrusion 28 in place within slot 20. Typically, the angle of taper will be in the range from about 0.5 degrees to about 5 degrees, and more preferably about 1.5 degrees. Also, the end of protrusion 28 may include small ridges 30. At the opposite end of protrusion 28 is a rib 32 which is generally perpendicular to a circular rib 34. Rib 32 provides structural stability and rigidity to protrusion 28 and provides a convenient way to attach it to rib 34. Ribs 32 and 34 may be chamfered or rounded to minimize the amount of drag. Also, in some cases it will be appreciated that buoyant member 12 could include surface grooves to reduce the amount by which ribs 32 and 34 extend from outer surface 16. Further, in some cases, such grooves could be sufficiently deep so that ribs 32 and 34 are generally flush with outer surface 16 of buoyant member 12.

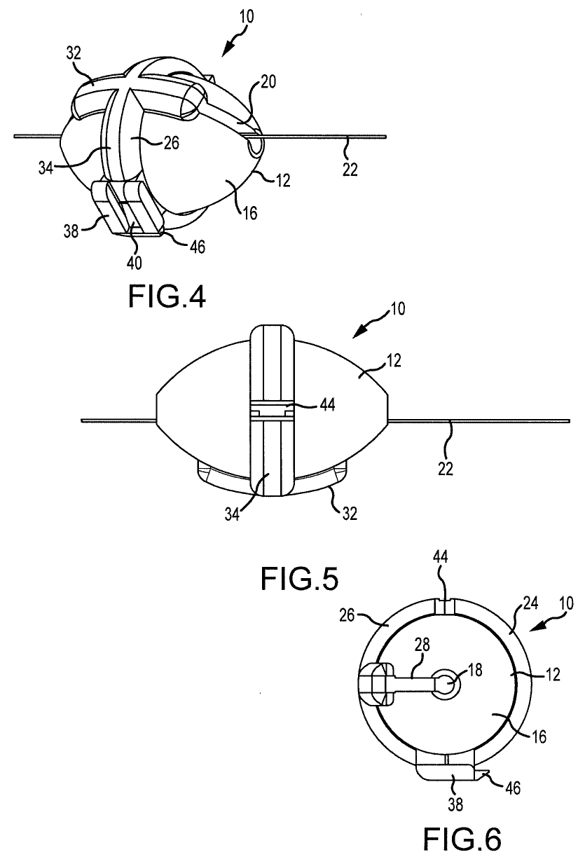

Second portion 26 of securing member 14 includes a rib 36 that is generally aligned with rib 34 when securing member 14 is placed in the closed position (see FIGS. 4-6). First portion 24 also includes a latch 38 while second portion 26 includes a notch 40. However, it will be appreciated that latch 38 and notch 40 could be located on either first portion or second portion 24 or second portion 26. When securing member 14 is placed in the closed position as illustrated in FIGS. 4-6, notch 40 fits within latch 38 with a snap fit to cinch securing member 14 radially about outer surface 16. In so doing, protrusion 28 is secured within slot 22 so that it will not slip out during casting or fishing. As best illustrated in FIG. 7, latch 38 includes an opening 42 through which notch 40 extends when snapping latch 38 into place. This is best illustrated in FIG. 4 which illustrates notch 40 within opening 42 and secured against latch 38. To remove securing member 14, latch 38 may be grasped with a finger and pulled away from buoyant member 12. In so doing, notch 40 disengages from latch 38 and slips through opening 42. First portion 24 may then be rotated relative to second portion 26 to loosen securing member 14 from outer surface 16. Protrusion 28 may then be pulled from the slot so that the line may be removed.

Conveniently, first portion 24 may be coupled to second portion 26 by a hinge 44. Conveniently, securing member 14 may be constructed of a single piece of material, such as an injected molded plastic so that hinge 44 is integrated with both first portion 24 and second portion 26. As such, hinge 44 may simply be a flexible piece of plastic that connects first portion 24 to second portion 26 and allows both portions to be rotated relative to each other. In some cases, hinge 44 may not be necessary and securing member 14 may be constructed of separate pieces of plastic which are coupled together.

Conveniently, tab 46 which may be grasped by a user's finger when attempting to unlatch the first portion from the second portion.

In use, a fisherman will select the size of strike indicator based on various fishing conditions, the type of fly, the amount of weight, the swiftness of the water, and the like. The bottom of slot 20 includes a piece of rubber upon which the fly line rests. Once the appropriate strike indicator is selected, the fishing line is placed into slot 20 until engaging the rubber piece and buoyant member 12 is moved to the appropriate position on the fishing line. Protrusion 28 is then inserted into slot 20 and forced in place so that it wedges the fishing line against the piece of rubber. At this point, the fishing line will be generally aligned with central axis 18. Second portion 26 is then rotated about the outer surface 16 of buoyant member 12 until notch 40 engages latch 38, with notch 40 snapping into place within opening 42. At this point, strike indicator 10 is securely coupled to the fishing line and the fly fisherman can safely cast the line without having strike indicator 10 slip along the line. If the fisherman needs to reposition or remove strike indicator 10, tab 46 is engaged and lifted to unlatch first portion 24 and second portion 26.

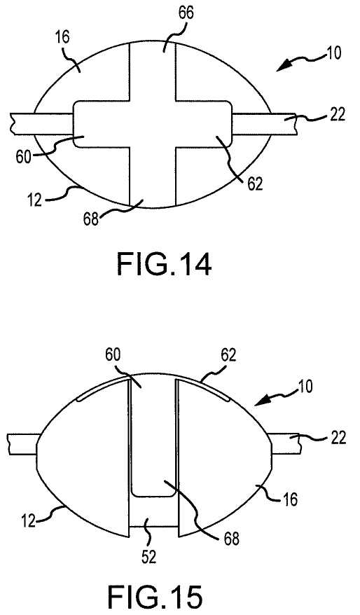

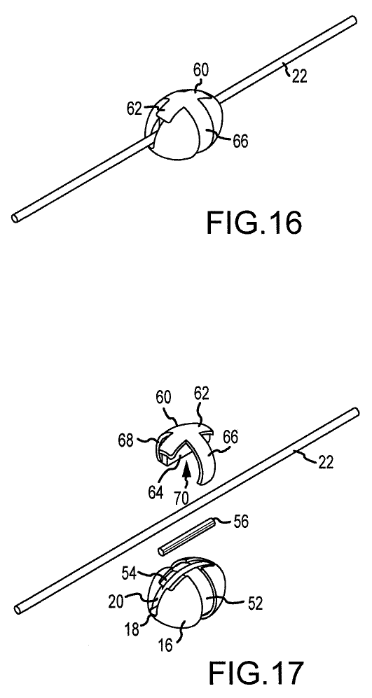

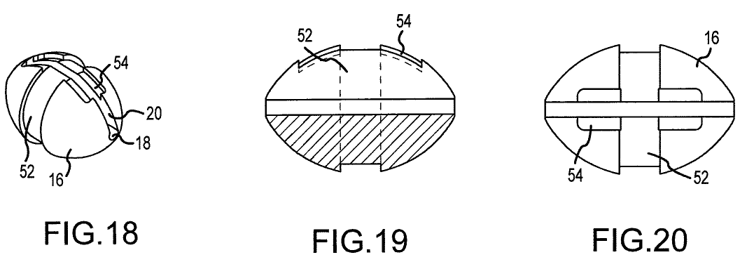

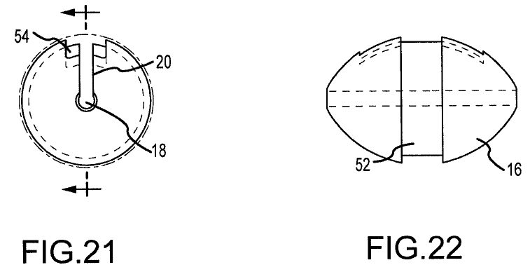

In some cases only a single piece of material may be used to construct securing member. For example, the securing member could comprise a rounded type of clip which is slipped about outer surface 16. Attention is now drawn to FIGS. 14-26 that illustrate an embodiment in which securing member 60 is made using a single piece of material. As best illustrated in FIGS. 17-22, securing member 60 may be used with buoyant member 12. As previously described, buoyant member 12 may be ellipsoidal (or football) shaped and may include a central axis 18 which passes through a geometric center of buoyant member 12. Similarly, extending from outer surface 16 to central axis 18 is a slot 20 into which the fishing line 22 is placed. Buoyant member 12 further includes a circumferential groove 52 positioned around the circumference of buoyant member 12 and a longitudinal groove 54 positioned longitudinally along slot 20. As described below, securing member 60 may be positioned with respect to circumferential groove 52 and longitudinal groove 54 so that securing member 60 is generally flush with outer surface 16 of buoyant member 12.

As best illustrated in FIG. 17, securing member 60 may include rib 62, first clip member 66, second clip member 68, and protrusion 64. Protrusion 64 extends from securing member 60 and is slidable within slot 20. Protrusion 64 may be slightly tapered as previously described to provide a press fit within slot 20. On the opposite end of protrusion 64 is rib 62, which is generally perpendicular to first and second clip members 66 and 68. Rib 62 may be shaped to correspond with longitudinal groove 54 so that rib 62 fits within longitudinal groove 54. In this manner, rib 62 may be generally flush with outer surface 16 when securing member 60 is attached to buoyant member 12.

Likewise, first and second clip members 66 and 68 may extend from rib 62 and may be generally circular in shape so that first and second clip members 66 and 68 fit radially around buoyant member 12 without fully encircling the circumference of buoyant member 12. A gap 70 exists between the end portions of first and second clip members 66 and 68. The gap may vary in width, but is generally not as wide as the maximum diameter of circumferential groove 52. In addition, first and second clip members 66 and 68 are resilient so that the clip members may flex, thereby allowing gap 70 to widen as securing member 60 is pressed onto buoyant member 12. Likewise, when securing member 60 is pressed onto buoyant member 12, the resiliency of first and second clip members 66 and 68 causes the clip members to return to their normal (i.e. un-flexed) position.

When pressed onto buoyant member 12, first and second clip members 66 and 68 releasably attach securing member 60 to buoyant member 12. As best illustrated in FIG. 26, when securing member 60 is attached to buoyant member 12, first and second clip members 66 and 68 fit radially around buoyant member 12 so that the end portions of first and second clip members are below central axis 18 when measured from rib 62. Because gap 70 is less then the maximum diameter of circumferential groove 52, the securing member is secured on buoyant member 12.

Similarly, the resiliency of first and second clip members 66 and 68 facilitate in decoupling or detaching securing member 60 from buoyant member 12. As securing member 60 is pulled away from buoyant member 12, first and second clip members 66 and 68 flex so that gap 70 widens to equal the maximum diameter of circumferential groove 52. After securing member 60 is removed from buoyant member 12, the resiliency of first and second clip members 66 and 68 causes the clip members to return to their normal (i.e. un-flexed) position.

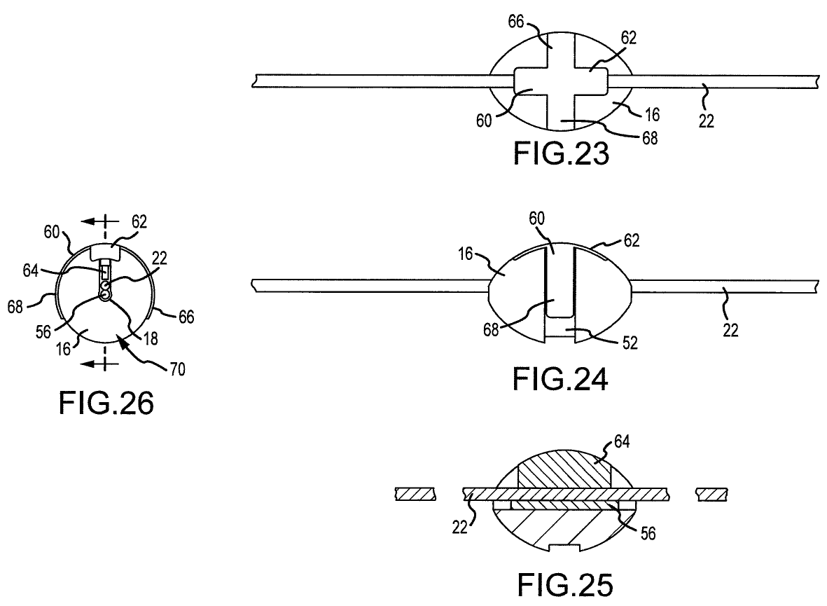

As best illustrated in FIGS. 23-26, first and second clip members 66 and 68 are shaped to correspond with circumferential groove 52 so that first and second clip members 66 and 68 fit within circumferential groove 52. In this manner, first and second clip members 66 and 68 may be generally flush with outer surface 16 when securing member 60 is attached to buoyant member 12. In addition, first and second clip members 66 and 68 are configured so that as securing member 60 is pressed onto buoyant member 12, the end portions of first and second clip members 66 and 68 slidingly engage with circumferential groove 52 and flex around the maximum diameter of circumferential groove 52 (i.e. gap 70 widens to equal the maximum diameter of circumferential groove 52). The end portions of first and second clip members 66 and 68 may be chamfered or rounded (not shown) to facilitate attaching securing member 60 to buoyant member 12 as first and second clip members 66 and 68 flex and the respective end portions slide around the circumference of circumferential groove 52.

In use, a fisherman will select the size of the strike indicator as described above. As illustrated in FIG. 17, a piece of rubber 56 may be inserted into slot 20 so that fishing line 22 rests on the piece of rubber 56. After the piece of rubber 56 is inserted into slot 20, the fishing line 22 is placed into slot 20 until it engages the rubber piece 56 and buoyant member 12 is moved to the appropriate position on the fishing line 22. Securing member 60 is then pressed onto buoyant member 12 so that protrusion 64 is inserted into slot 20 and so that first and second clip members 66 and 68 slidingly engage with circumferential groove 52.

As securing member 60 is pressed onto buoyant member 12, such as by a user grasping rib 62 and pressing securing member 60 onto buoyant member 12, first and second clip members 66 and 68 flex so that gap 70 widens as the end portions of first and second clip members 66 and 68 slide along circumferential groove 52. After the end portions of first and second clip members 66 and 68 are pressed past the maximum diameter of circumferential groove 52 (i.e. after gap 70 widens to equally the maximum diameter of circumferential groove 52), the resiliency of first and second clip members 66 and 68 helps to force securing member 60 in place on buoyant member 12 (i.e. the resiliency helps snap securing member 60 onto buoyant member 12). When fully pressed onto buoyant member 12, rib 62 resides within longitudinal groove 54 and first and second clip members 66 and 68 reside within circumferential groove 52 so that securing member 60 is generally flush with buoyant member 12. In this position, securing member 60 is secured or locked in place on buoyant member 12 as best shown in FIGS. 14-16.

As shown in FIGS. 25 and 26, as securing member 60 is attached to buoyant member 12, protrusion 64 is forced in place so that it wedges the fishing line 22 against the piece of rubber 56. At this point, the fishing line 22 will be generally aligned with central axis 18. At this point, the strike indicator is securely coupled to the fishing line 22 and the fly fisherman can safely cast the line without having the strike indicator slip along the line. If the fisherman needs to reposition or remove the strike indicator, securing member 60 may be grasped (such as by grasping rib 62) and pulled away from buoyant member 12. As securing member 60 is pulled away from buoyant member 12, first and second clip members 66 and 68 flex as the respective end portions slide along the circumference of circumferential groove 52. After securing member 60 is removed, the line may be withdrawn from slot 20 or the strike indicator may be moved on the fishing line 22.

The invention has now been described in detail for purposes of clarity and understanding. However, it will be appreciated that certain changes and modifications may be practiced within the scope of the appended claims.

What is claimed is:

1. A strike indicator for a fishing line, the strike indicator comprising:
a buoyant member having a curved outer surface, a central axis, and a slot extending from the outer surface to the central axis, wherein the slot is adapted to receive a fishing line; and
a securing member removably coupled to the outer surface of the buoyant member, the securing member having a protrusion that is positionable within the slot to secure the fishing line within the slot such that the line does not slide within the slot when casting the line.

2. A strike indicator as in claim 1, wherein the securing member further comprises a first half, a second half and a hinge connecting the first half and the second half, and wherein the protrusion extends from the first half.

3. A strike indicator as in claim 2, wherein the first and second halves are semi-circular in geometry and match the outer surface of the buoyant member.

4. A strike indicator as in claim 3, wherein the protrusion is perpendicular to the first half.

5. A strike indicator as in claim 2, wherein the securing member includes a clasp to releasably couple the first half to the second half.

6. A strike indicator as in claim 1, wherein the buoyant member is football shaped.

7. A strike indicator as in claim 1, wherein the buoyant member is constructed of a material selected from a group consisting of closed cell foam.

8. A strike indicator for a fishing line, comprising:
an ellipsoid-shaped buoyant member having an outer surface, a central axis and a slot ending from the outer surface to the central axis, wherein the slot is adapted to hold a fishing line;
a securing member comprising a first curved section and a second curved section, wherein one of the first or second sections includes a protrusion that fits within the slot of buoyant member, and wherein the securing member further includes a securing arrangement to couple the first and second sections together after the protrusion is positioned within the slot.

9. A strike indicator as in claim 8, wherein the first and second sections are connected with a hinge and wherein the securing arrangement comprises a notch that is configured to snap fit into a latch.

10. A strike indicator as in claim 8, wherein the buoyant member is constructed of a material selected from a group consisting of closed cell foam.

11. A method for attaching a strike indicator to a fishing line, the method comprising:
providing a buoyant member comprising an outer surface, a central axis and a slot extending from the outer surface to the central axis;
placing a fishing line into the slot so that it is generally aligned with the central axis; and
placing a securing member about the outer surface such that a protrusion on the securing member is with the slot.

12. A method as in claim 11, wherein the securing member includes two halves and further comprising locking the two halves together after placing the protrusion within the slot.

13. A method as in claim 11, wherein the securing member is placed radially about the buoyant member such that the securing member is perpendicular to the protrusion.

14. A method as in claim 11, further comprising removing the securing member from the buoyant member and removing the line from the slot.

15. A method as in claim 11, further comprising casting the line while the buoyant member is coupled to the line.

16. A strike indicator as in claim 1, wherein the securing member comprises a single piece that includes a first clip member and a second clip member that are roughly perpendicular to the protrusion and that fit radially around the buoyant member without fully encircling the buoyant member.

17. A method as in claim 11, wherein the securing member includes a single piece having a clip member and further comprising pressing the securing member onto the buoyant member such that the clip member fits radially around the buoyant member without fully encircling the buoyant member.

18. A strike indicator as in claim 16, wherein the buoyant member comprises a circumferential groove that corresponds with the first clip member and the second clip member such that the first and second clip members are generally flush with the curved outer surface of the buoyant member when the securing member is coupled to the buoyant member.

19. A method as in claim 11, further comprising snapping the securing member in place on the buoyant member, wherein the securing member comprises a first resilient clip member and a second resilient clip member, and wherein the resiliency of the first and second clip members snap the securing member in place on the buoyant member and thereby couple the securing member to the buoyant member.

20. A method as in claim 11, further comprising placing a piece of rubber into the slot before placing the fishing line into the slot, the piece of rubber facilitating in attaching the strike indicator to the fishing line.
